(19) United States
(12) Patent Application Publication
(10) Pub. No.: US 2004/0143038 A1
(43) Pub. Date: Jul. 22, 2004

(54) Age-stable composition having a polysaccharide

(76) Inventor: Thomas Aberle, Sempach-Station (CH)

Correspondence Address: Thomas F. Roland, NATIONAL STARCH AND CHEMICAL COMPANY, P.O. Box 6500, Bridgewater, NJ, 08807-0500, US

(21) Appl. No.: 10/346,267

(22) Filed: Jan. 16, 2003

(51) Int. Cl. C08L 1/00; C08L 5/00

(52) U.S. Cl. 524/27; 524/55

(57) ABSTRACT

The present invention is directed to a building composition containing a polysaccharide, an organic polymer binder and an aging stabilizer. The aging stabilizer helps minimizes viscosity loss of the wetted composition, thereby providing anti-aging viscosity stability. The composition may contain gypsum or be gypsum-free and cement-free.

### FIELD OF THE INVENTION

This invention relates to a composition having a polysaccharide, an organic polymer binder, and an aging stabilizer. The aging-stabilizer allows the composition to maintain a nearly constant initial wetted viscosity, independent of the storage time of the dry composition. The composition is preferably a gypsum plaster or a gypsum-free and cement-free plaster containing a film-forming polymer.

### BACKGROUND OF THE INVENTION

Building compositions, such as plasters, and mortars, generally contain a binder and filler. In addition to the binder and filler, the composition often includes a number of additives that improve the working and finished properties of the composition. U.S. Pat. No. 6,409,825 describes several wet gypsum accelerators, including glycine, and sodium D-gluconate.

U.S. Pat. No. 6,080,806 describes the addition of redispersible carboxylic-functional polymers and amino acids to mortar or concrete. The dried polymer/amino acid mixture is stable on storage without agglomeration. There is no mention of polysaccharides in the formulations or any issues of storage stability.

U.S. Pat. No. 6,402,832 describes a gypsum wallboard joint compound containing water soluble cationic polymers having nitrogen (amine or substituted amine) groups to reduce the moisture content and improve the strength of finished wallboard.

Stability of a wetted plaster is an important property. U.S. Pat. No. 3,652,309 describes a gypsum plaster having a high degree of stability, and one that in dry storage drops only slightly in mortar consistency. The improvement is accomplished by using only calcined gypsum having a particle size of less than 32 microns.

Polysaccharides are often used as plaster additives to improve water retention, consistency, adhesion and plasticization. Even small amounts of polysaccharides can delay the rapid uptake of water by the adsorbent substrate, ensuring that the water remains present for uniform setting and hardening. This prevents the premature drying of the plaster, permitting longer working times.

One problem seen in plaster formulations containing polysaccharides is that the initial viscosity of a wetted plaster decreases in relation to the storage time of a dry powder composition. While not being bound by any particular theory, it is believed that the viscosity loss is due to a degradation of the polysaccharide during storage.

U.S. Pat. No. 5,932,001 describes a plaster containing an amylaceous additive that is effective as a plaster thickener. There is no recognition of an initial viscosity loss related to dry storage time, and no mention of a compound providing aging stability.

There is a need for a composition, useful in building applications, that contains polysaccharides and exhibits an initial wet viscosity that is not dependent on the storage time of the dry composition.

Surprisingly it has been found that the inclusion of small amounts of an aging stabilizer in a dry composition having a polysaccharide and an organic polymer binder results in a nearly constant initial wet viscosity regardless of the dry storage time.

### SUMMARY OF THE INVENTION

It is an objective of the present invention to obtain a composition containing a polysaccharide and an organic polymer binder that is age stable.

It is a further objective to provide a method for obtaining a dry composition that is age stable.

It is a further objective to provide both gypsum and gypsum-free building compositions having a polysaccharide and an organic polymer binder that are age stable, independent of dry storage time.

These objectives have been achieved by the present invention that relates to a composition comprising from 0.01 to 99.9 percent by weight of at least one polysaccharide; 0.0001 to 50 percent by weight, of at least one aging stabilizer; and from 0.1 to 99.9 percent by weight of at least one organic polymer binder, all weight percentages based on the amount of dry composition solids.

The invention also relates to a method for increasing the age stability of a dry building composition containing at least one polysaccharide, by combining into said dry composition an aging stabilizer.

### DETAILED DESCRIPTION OF THE INVENTION

The compositions of the present invention are pliable mixtures of various materials with water, which dry or set to form a coherent solid. The composition may be used as building compositions in the form of a plaster or mortar, generally containing gypsum, lime, or a film-forming polymer.

By “aging stability” and “age-stable” as used herein is meant that the initial viscosity of a wetted dry powder composition remains nearly constant, regardless of the length of time the dry composition is stored or “aged”. An age stable composition can be defined as one which when stored as a dry mix in a sealed container at 40° C. for 10 days and mixed with water will have an initial viscosity that is reduced by no more than 25 percent of the viscosity of an un-aged mixture, and preferably by no more than 15 percent of the un-aged mixture. In the case of a paste composition, “aging stability” and “age-stability” as used herein is meant that the paste retains essentially the same viscosity for at least six months. Essentially the same viscosity meaning less than a 15 percent decrease in viscosity of the paste over a six month period when stored in a sealed container at standard conditions of 23° C. and 50 percent relative humidity.

By “aging stabilizer”, as used herein, is meant a compound or compounds added to a composition containing a polysaccharide and a binder, which causes the composition to have age stability as defined above. The aging stabilizer does not encompass biocides.

The invention relates to a composition containing polysaccharide, binder, and aging stabilizer. The invention preferably relates to an age-stable dry plaster or mortar, gypsum or gypsum-free composition.

Polysaccharides are used in building compositions to improve water retention, consistency, adhesion and plasticization. Polysaccharides useful in the composition of the invention include starches and modified starches, cellulose, cellulose ethers, xanthan gum, guar gum, guar ethers, alginates, and Wellan gums. Particularly useful polysaccharides are cellulose ethers and guar ethers. Useful cellulose ethers include, but are not limited to methylcellulose (MC), ethyl cellulose (EC), hydroxyethyl cellulose (HEC), hydroxypropyl cellulose (HPC), methylhydroxyethylcellulose MH EC), ethyl hydroxyethyl cellulose (EH EC), ethylhydroxypropyl cellulose (EHPC), methylhydroxyethylcellulose MHEC), methylhydroxypropylcellulose (MHPC), and carboxymethyl cellulose (CMC).

Polysaccharides are present in the plaster composition at from 0.01 to 99.9 percent by weight, preferably 0.01 to 50 percent by weight, and most preferably 0.01 to 10 percent by weight, based on the dry composition.

The aging stabilizer is a compound or compounds that provide age stability to the composition. Aging stabilizers include, but are not limited to, one or more amino acids, amines, carboxylic acids, thiols, amides; and polymers containing amino acid, amine, carboxylic acid, thiol, or amides functionality. The amount of aging stabilizer in the dry composition is in the range of 0.0001 to 50 percent by weight, preferably from 0.0001 to 20 percent by weight, and most preferably from 0.0001 to 2 percent by weight. The ratio of aging stabilizer to polysaccharide and binder, on a solids basis, is in the range of 1 part aging stabilizer to 1 to 200 parts of polysaccharide, and 1 to 1000 parts of organic polymer binder.

A preferred class of aging stabilizers are amino acids. Amino acids useful in the present invention include, but are not limited to alanine, arginine, asparagine, aspartic acid, cysteine, cystine, 3,5-dibromotyrosine, diiodotyrosine, glutamic acid, glutamine, glycine, histidine, hydroxylysine, hydroxyproline, isoleucine, leucine, lysine, methionine, phenylalanine, proline, serine, threonine, thyroxine, tryptophane, tyrosine, valine. A particularly preferred amino acid is glycine. Since the composition will often exist as a water-redispersible powder, the amino acids in the composition preferably have good water solubility. Solubility of the amino acids may be increased by full or partial neutralization to form amino acid salts. Preferably the amino-acid salts are in the form of sodium, potassium, ammonium, and calcium salts.

A functional polymer incorporating one or more amino acid, amine, amide, carboxylic acid, and/or thiol functional groups may also serve as the aging stabilizer. The functional groups may be incorporated by many methods, including but not limited to homopolymerization of a functional monomer, copolymerization of one or more functional monomers with one or more non-functional monomer, grafting of a functionality onto the polymer backbone, post-polymerization reactions, or other means known in the art. Examples of functional monomer includes, but is not limited to, acrylic acid, 2-acrylamido-2-methyl propane sulfonic acid, sodium methallyl sufonate, sodium vinyl sulfonate, sulfonated styrene, allyloxybenzene sulfonic acid, methacrylic acid, ethacrylic acid, alpha-chloro-acrylic acid, alpha-cyano acrylic acid, alpha-chloro-acrylic acid, alpha-cyano acrylic acid, beta methyl-acrylic acid (crotonic acid), alpha-phenyl acrylic acid, beta-acryloxy propionic acid, sorbic acid, alpha-chloro sorbic acid, angelic acid, cinnamic acid, p-chloro cinnamic acid, beta-styryl acrylic acid (1-carboxy-4-phenyl butadiene-1,3), itaconic acid, maleic acid, citraconic acid, mesaconic acid, glutaconic acid, aconitic acid, fumaric acid, and tricarboxy ethylene, N,N dialkylaminoalkyl(meth)acrylate, N,N dialkylminoalkylacrylate, dialkylaminoalkyl(meth)acrylamide and N,N dialkylminoalkylacrylamide, where the alkyl groups are independently C₁₋₁₈. Aromatic amine containing monomers such as vinyl pyridine may also be used. Furthermore, monomers such as vinyl formamide, vinylacetamide etc which generate amine moieties on hydrolysis may also be used. N,N-dimethylaminoethyl methacrylate, N,N-dimethylaminopropyl methacrylamide. N,N dialkylaminoalkyl(meth)acrylate, N,N dialkylminoalkylacrylate, dialkylaminoalkyl(meth)acrylamide and N,N dialkylminoalkylacrylamide, where the alkyl groups are independently C₁₋₁₈. Aromatic amine containing monomers such as vinyl pyridine may also be used. Furthermore, monomers such as vinyl formamide, vinylacetamide etc which generate amine moieties on hydrolysis may also be used. Preferably the hydrophilic acid-neutralizable monomer is N,N-dimethylaminoethyl methacrylate, and N,N-dimethylaminopropyl methacrylamide, carboxylic, dicarboxylic, sulfonic, and phosphonic acids, or mixtures thereof. Examples of said monomers useful in the present invention include, but are not limited to acrylic acid, methacrylic acid, maleic anhydride, itaconic acid, crotonic acid, styrene sulfonic acid, 2-acrylamido-2-methylpropane sulfonic acid, vinyl sulfonic acid, ethacrylic acid, alpha-chloro-acrylic acid, alpha-cyano acrylic acid, beta methyl-acrylic acid (crotonic acid), alpha-phenyl acrylic acid, sorbic acid, alpha-chloro sorbic acid, angelic acid, cinnamic acid, p-chloro cinnamic acid, beta-styryl acrylic acid (1-carboxy-4-phenyl butadiene-1,3), itaconic acid, maleic acid, citraconic acid, mesaconic acid, glutaconic acid, aconitic acid, fumaric acid, tricarboxy ethylene, 2-acryloxypropionic acid, vinyl sulfonic acid, phosphoric acid, vinyl phosphonic acid, methallyl sulfonic acid, sulfonated styrene, and allyloxybenzenesulfonic acid. acrylamide, N, N-dimethylacrylamide, N-octyl acrylamide, N-methylol acrylamide, dimethylaminoethylacrylate, vinyl pyrrolidone, vinyl imidazolidone, N-vinyl formamide, N-vinyl acetamide, dimethylaminoethyl acrylate, dimethylaminoethyl methacrylate, diethylaminoethyl acrylate, diethylaminoethyl methacrylate, dimethylaminopropyl acrylate, dimethylaminopropyl methacrylate, diethylaminopropyl acrylate, diethylaminopropyl methacrylate, dimethylaminobutyl acrylate, dimethylaminobutyl methacrylate, dimethylaminoneopentyl acrylate, dimethylaminoneopentyl methacrylate, dimethylaminoethylacrylamide, dimethylaminoethylmethacrylamide, diethylaminoethylacrylamide, diethylaminoethylmethacrylamide, dipropylaminoethylacrylamide, dipropylaminoethylmethacrylamide, dimethylaminopropylacrylamide, dimethylaminopropylmethacrylamide, diethylaminopropylacrylamide, diethylaminopropylmethacrylamide, dimethylaminoneopentylacrylamide, dimethylaminoneopentylmethacrylamide and dialkylaminobutylacrylamide. The functional monomer or monomers, if incorporated into a polymer as the aging stabilizer, may form a homopolymer, or may are present at any ratio up to 100 percent by weight, based on the weight of the polymer.

The binder of the invention is an organic polymer binder. The polymer may be any known synthetic polymer, copolymer, or mixture thereof. The polymer should be film-forming and water-soluble or water-dispersible. The polymer may be synthesized by solution, emulsion, inverse emulsion, suspension or other polymerization method. The polymer may be random, block, star, or other known polymer architecture. Polymers useful in a building composition will typically have a Tg in the range of from −60° C. to +40° C. In a dry composition, the polymer must be easily redispersible in water. The polymer binder is present in the composition at a level of from 0.01 to 99.9 percent, preferably from 0.01 to 90 percent, and most preferably from 0.01 to 50 percent, based on the dry weight of polymer to dry weight of the composition.

A preferred class of polymers are emulsion polymers formed from ethylenically unsaturated monomers. Useful monomer include, but not limited to, (meth)acrylates, maleates, (meth)acrylamides, vinyl esters, itaconates, styrenics, unsaturated hydrocarbons and acrylonitrile, nitrogen functional monomers, vinyl esters, ethylene, and alcohol functional monomers. Particularly useful polymers include vinyl acetate homopolymers; ethylene/vinyl ester copolymers such as vinyl acetate/ethylene copolymers (EVA), EVAs with other comonomers, ethylene/vinyl versatate copolymers; vinyl ester/(meth)acrylate copolymers; styrene/acrylic copolymers; styrene butadiene copolymers. In a preferred embodiment, the polymer is synthesized using polyvinyl alcohol as the stabilizer. In another embodiment, the polymer binder is free of carboxylic- and (meth)acrylamide- functional monomer units.

The polymeric binder may also contain some cationic functionality, and may be produced by the method described in U.S. patent applications Ser. No. 09/744,089 (WO 200005283), and Ser. No. 09/744,082 (WO 200005275), incorporated herein by reference.

In addition to the polysaccharide, aging stabilizer, and organic polymer binder, one or more adjuvants may also be present in the composition at from 0 to 99.9 percent, preferably 0 to 99 percent and most preferably from 5 to 98 percent by weight, based on the composition solids. These adjuvants may be one or more compounds selected from inorganic binders, accelerators, retarders, fillers, wetting agents, defoamers, superplasticizers, coalescing agents, plasticizers, and other additives known in the art. Typical fillers include, but are not limited to, calcium carbonate, sand, quartz, silica, kaolin, barium sulfate, titanium oxide, talc, and hydrated alumina.

Inorganic binder adjuvants include, but are not limited to, gypsum, and lime. When inorganic binders are used in the composition, they are generally present at from 10 to 99.9 percent by weight, preferably from 15 to 99 percent by weight, and most preferably from 20 to 98 percent by weight. A mixture of both organic polymer binder and inorganic binder in the composition may be useful to obtain the best level of product performance and cost.

In one embodiment, the composition of the invention includes one or more superplasticizers. Superplasticizers, also known as cement superplasticizers include, but are not limited to, casein and other natural substances, melamine-formaldehyde condensates, sulfonated napthalin-formaldehyde condensates, modified lignosulfonates, polycarboxylates, polyacrylates, polystyrene sulfonates, and sulfonic esters. The superplasticizer is present in the composition at a ratio of 0.01 to 2 parts of superplasticizer to 1 part polysaccharide, on a weight to weight basis.

The individual components may be combined in any number of ways, and in any combination, to form the final composition of the present invention. All components may be formed into the dry state, and be admixed together. Two or more ingredients may be combined in a wet state, and dried together. As previously mentioned, the polymer binder may be functionalized with the aging stabilizer either through the copolymerization of a functional monomer, or a post-polymerization reaction.

Several examples are provided to illustrate many different methods for combining the many components. One of skill in the art could imagine other methods to produce the final composition.

In one process, the polysaccharide and/or aging stabilizer may be combined with a latex polymer, and the mixture dried by means known in the art, such as by spray-drying, freeze-drying, or drum drying. The polysaccharide and/or aging stabilizer may also be associated with a polymer dispersant, such as polyvinyl alcohol, which may be used as a stabilizer in an emulsion polymerization of a polymer additive. The polysaccharide and/or aging stabilizer may be combined with an aqueous polymer solution or emulsion in a spray-drying tower, and sprayed and dried together. In still another embodiment the polysaccharide and/or aging stabilizer may be dried in separate operations, then the dry components blended together.

Another process involves combining the polysaccharide and aging stabilizer. This combination can either be added in an aqueous dispersion with other ingredients, or the combination may be dried, then admixed with other dry ingredients.

The compositions of the present invention will have a pH of from 4 to 10 when blended with water into a 50 percent by weight paste. At higher pH, the problems associated with polysaccharide degradation are mitigated by the highly alkaline environment.

The compositions of the invention may be used in several end-use applications. A particularly preferred application would be as a building composition. One building application of the composition is as a plaster. The plaster typically contains gypsum or lime as the binder, and will often also contain some organic polymer binder for improved properties such as adhesion. A dry gypsum plaster or mortar composition is one that is ready to use with the addition of only water. Some uses for the plaster include, but are not limited to coatings, surfacing plasters, projection plasters, plasters for smooth supports, plasters for floor finishing, plasters for facing of imitation brickwork, plaster for both exterior and interior coatings. The plaster may be in the form of a redispersible powder, a fluid paste, hardened paste, or finished products. The building composition is also useful for forming gypsum boards. Gypsum rich products may contain up to 99.9 percent by weight of gypsum. Filled-gypsum products contain about 30 percent gypsum and a large amount of filler. The dry building composition may also be a gypsum-free, cement-free plaster composition.

A gypsum-free building composition typically exists as an aqueous-based dispersion or paste containing a polymer binder, filler, polysaccharide, and the aging stabilizer. The gypsum-free composition is useful for formulating ceramic tile adhesive (CTA), repair mortar, and other known gypsum-free products. The polymer binder is present at from 2 to 50 percent by weight, and preferably from 5 to 15 percent by weight, based on dry polymer to dry composition. A one-pack gypsum-free product will typically contain from 7 to 15 percent by weight of polymer on a solids to solids basis. The gypsum-free, cement-free composition may be combined with a cement just prior to final use, as part of a two-part system.

The composition of the invention may also be a medicinal or pharmaceutical plaster, often used for applications involving the sustained release of active ingredients.

The following examples are presented to further illustrate and explain the present invention and should not be taken as limiting in any regard.

### EXAMPLE 1 (COMPARATIVE)

A dry gypsum formulation was prepared by blending 97.5 weight percent of alpha plaster gypsum, 0.5 percent by weight of cellulose ether (10-20 Pas), and 2 percent by weight of a redispersible polymer powder. The polymer powder is an ethylene-vinyl acetate copolymer.

### EXAMPLE 2

A dry gypsum formulation was prepared as in Example 1, using as the polymer powder an ethylene-vinyl acetate powder to which 1.6 percent by weight of glycine has been added prior to spray drying.

### EXAMPLE 3

A dry gypsum formulation was prepared as in Example 2, using as the polymer powder an ethylene-vinyl acetate powder to which 0.5 percent by weight of glycine has been added.

### EXAMPLE 4 (COMPARATIVE)

A dry gypsum formulation was prepared as in Example 1, using as the polymer powder a vinyl acetate/VeoVa powder.

### EXAMPLE 5

A dry gypsum formulation was prepared as in Example 2, using as the polymer powder a vinyl acetate/VeoVa powder to which 1.6 percent by weight of glycine has been added.

### EXAMPLE 6 (COMPARATIVE)

A dry gypsum formulation was prepared as in Example 1, using as the polymer powder a acrylic polymer powder.

### EXAMPLE 7

A dry gypsum formulation was prepared as in Example 2, using as the polymer powder an acrylic powder to which 1.6 percent by weight of glycine has been added.

### EXAMPLE 8

### Aging Stability Test

The dry gypsum formulations of Examples 1-7 were stored in sealed containers at 40° C. for 0 to 10 days. 100 g of the dry gypsum formulation was cooled to room temperature and then mixed with 55 g of water. The mixture was stirred for 60 seconds. The results appear in Table I below. The viscosity of the wetted formulation was measured 5 minutes after mixing is completed, using a Brookfield viscometer (spindle No. 7, at 20 rpm). Without the aging stabilizer (glycine), there is a marked loss of viscosity seen even after one day of storage. The samples containing glycine retained nearly constant viscosity independent of storage time.

“NM” stands for No longer Measured. The symbol “- - - ” indicates that no viscosity measurement was taken on that day.

TABLE I

| | Ex. 1 | | | Ex. 4 | | Ex. 6 | |
|---|---|---|---|---|---|---|---|
| Storage | (comp) | Ex. 2 | Ex. 3 | (comp) | Ex. 5 | (comp) | |
| time, | Visc. | Visc. | Visc. | Visc. | Visc. | Visc. | Ex. 7 Visc. |
| days | Pas | Pas | Pas | Pas | Pas | Pas | Pas |
| 0 | 105 | 116 | 104 | 116 | 136 | 113 | 134 |
| 1 | 19.2 | 116 | 106 | 31.2 | 134 | 35.2 | 132 |
| 2 | 16.0 | 118 | 105 | 21.6 | 136 | 25.6 | 132 |
| 3 | 15.2 | 120 | — | 20.8 | 132 | 21.6 | 134 |
| 4 | NM | 112 | 104 | NM | 134 | NM | 121 |
| 5 | NM | — | — | NM | — | NM | — |
| 6 | NM | — | — | NM | — | NM | — |
| 7 | NM | 118 | 110 | NM | 132 | NM | 131 |
| 8 | NM | 119 | 104 | NM | 130 | NM | 128 |
| 9 | NM | 118 | 102 | NM | 130 | NM | 130 |
| 10 | NM | 118 | 100 | NM | 130 | NM | 129 |

### EXAMPLE 9

### Gypsum Plaster

A gypsum plaster is formulated by blending 57.5 weight percent gypsum (alpha plaster), 40 weight percent calcium carbonate, 0.5 weight percent cellulose ether (10-20 Pas), and 2 weight percent of a redispersible powder of an ethylene-vinyl acetate copolymer containing 1.6 percent by weight glycine.

### EXAMPLE 10

### Two Component Ceramic Tile Adhesive

A two component ceramic tile adhesive is prepared by forming as component 1:

15 weight percent water

16 weight percent sand 0.1-0.3 mm

48.5 weight percent Calcium carbonate

0.5 weight percent cellulose ether (10-20)

20 weight percent aqueous dispersion of polymer binder (50% solids ethylene-vinyl acetate having 1.6 percent glycine).

and as component 2

100 weight percent cement

Component 1 and component 2 are then mixed in a ratio of about 80:20 to 70:30, directly before use.

### EXAMPLE 11

### Pasty Ceramic Tile Adhesive

A pasty ceramic tile adhesive is formulated by admixing

18 weight percent water

0.1 weight percent biocide

0.05 weight percent defoamer

0.35 weight percent cellulose ether (50 Pas)

13.2 weight percent aqueous dispersion of organic binder based on EVA and having 1.6 percent glycine; 50% solids

68.3 weight percent quartz sand 2-75 micron.

What is claimed is:

1. A composition having aging stability comprising:
a) 0.01 to 99.9 percent by weight of at least one polysaccharide;
b) 0.0001 to 50 percent by weight of at least one aging stabilizer;
c) 0.01 to 99.9 of at least one organic polymer binder; and
d) 0 to 99.9 percent by weight of at least one adjuvant,
wherein the percentages are based on the composition solids, and add up to 100 percent.

2. The composition of claim 1 comprising:
a) 0.01 to 50 percent by weight of at least one polysaccharide;
b) 0.0001 to 20 percent by weight at least one aging stabilizer;
c) 0.01 to 90 percent by weight of at least one organic polymer binder; and
d) 0 to 99 percent by weight of at least one adjuvant,
wherein the percentages are based on the composition solids, and add up to 100 percent.

3. The composition of claim 2 comprising:
a) 0.01 to 10 percent by weight of at least one polysaccharide;
b) 0.0001 to 2 percent by weight of at least one aging stabilizer;
c) 0.01 to 50 percent by weight of at least one organic polymer binder; and
d) 38 to 98 percent by weight of at least one adjuvant,
wherein the percentages are based on the composition solids, and add up to 100 percent.

4. The composition of claim 1, wherein said composition comprises a water-redispersible dry powder.

5. The composition of claim 1, wherein said composition comprises an aqueous-based dispersion or paste.

6. The composition of claim 1, wherein said polysaccharide comprises one or more polysaccharide ethers selected from the group consisting of cellulose ethers, and guar ethers.

7. The composition of claim 1 wherein said adjuvant comprises gypsum, lime, fillers, or a mixture thereof.

8. The composition of claim 1 wherein said aging stabilizer comprises an amino acid, a functional polymer, or a mixture thereof.

9. The composition of claim 8 wherein said amino acid comprises glycine.

10. The composition of claim 1 wherein said composition when made into a 50 percent by weight aqueous solution has a pH of less than 10.

11. The composition of claim 1 wherein said adjuvant comprises at least one superplasticizer.

12. A composition having aging stability comprising:
a) 0.0001 to 20 percent by weight of at least one aging stabilizer;
b) 0.1 to 99.9 of at least one polymeric binder; and
c) gypsum,
wherein said composition is a water-redispersible dry powder, and wherein the percentages are based on the composition solids, and add up to 100 percent.

13. A method for increasing the aging stability of a building composition comprising combining 0.01 to 99.9 percent of at least one polysaccharide, 0.0001 to 50 percent by weight of at least one aging stabilizer, 0.01 to 99.9 percent by weight of at least one binder, and 0 to 99.9 percent by weight of other adjuvants to form a building composition.

14. The method of claim 13 wherein said polysaccharide and said aging stabilizer are combined in an aqueous form and the combination dried prior to combination with the other ingredients.

15. The method of claim 13 wherein said binder comprises an organic polymer, and wherein said aging stabilizer and said organic polymer are combined in the aqueous state and the combination dried prior to combination with the other ingredients.

16. The method of claim 13 wherein said binder comprises an organic polymer, and wherein said aging stabilizer and said organic polymer are individually dried, then the two ingredients combined in the dry form, prior to combination with the other ingredients.

17. A formed product comprising
a) 0.01 to 99.9 percent by weight of at least one polysaccharide;
b) 0.0001 to 50 percent by weight, of at least one aging stabilizer, based on the amount of dry solids;
c) 0.01 to 99.9 of at least one binder, wherein said binder is selected from inorganic binders, organic binders, or a mixture thereof; and
d) 0 to 99.9 percent by weight of at least one adjuvant.
